(19) United States
(12) Patent Application Publication
(10) Pub. No.: US 2013/0263687 A1
(43) Pub. Date: Oct. 10, 2013

(54) Automatic Tensioning Device for Parking Brakes

(71) Applicant: BATZ, S.COOP., Igorre (ES)

(72) Inventor: Fernando BURGUERA ALBIZURI, BILBAO (ES)

(73) Assignee: BATZ, S.COOP., Igorre (ES)

(21) Appl. No.: 13/855,613

(22) Filed: Apr. 2, 2013

(30) Foreign Application Priority Data
Apr. 4, 2012 (ES) P201230523

(51) Int. Cl. F16C 1/22

(52) U.S. Cl. CPC F16C 1/22
USPC 74/501.5 R

(57) ABSTRACT

An automatic tensioning device for a parking brake actuator that according to one implementation includes a support, a first regulating element, and a second regulating element movable with respect to the support between a rest position and a block position. The second regulating element includes an inner thread, a first stop surface for contacting the support, and at least one stop for contacting the support and/or the first regulating element. In the rest position, the first regulating element is moved with respect to the second regulating element by means of rotation of the second regulating element when the first stop surface contacts a first stop surface of the support. In the block position, the stop blocks the rotation of the second regulating element with respect to the first regulating element.

### CROSS-REFERENCE TO RELATED APPLICATIONS

The present application relates to and claims the benefit and priority to Spanish Patent Application No. P201230523, filed Apr. 4, 2012.

### TECHNICAL FIELD

The present disclosure relates to parking brakes having an automatic cable tensioning device.

### BACKGROUND

Cable tensioning devices suitable for parking brakes intended for maintaining the tension of the brake cables that will be connected to the brakes of the corresponding motor vehicle are known. The devices comprise automatically adjustable regulating means for adjusting the tension such that if the brake cable loses tension in a rest position of the parking brake, the automatic tensioning device acts on the cable tensioning it, if necessary.

U.S. Publication No. US2009/0314122 discloses a parking brake comprising a tensioning device. The tensioning device includes a toothed bar which is fixed at one end to a brake cable of the motor vehicle. An elastic means acts on the toothed bar to move it when the cable loses tension. A pawl is provided which engages the toothed bar preventing the toothed bar from moving in a direction that reduces tension in the brake cable.

Spanish Patent No. ES2160537B1 discloses a tensioning device comprising a toothed bar having a circular section which is fixed at one end to a brake cable of the motor vehicle. An elastic means acts on the toothed bar to move it when the cable loses tension. A support housing is provided with two wedged side parts disposed therein. The wedged parts comprise teeth, being arranged surrounding the toothed bar. The elastic means acts on the wedged side parts blocking the movement of the bar towards the direction opposite the elastic means.

International Publication No. WO2009/127047A1 discloses a self-adjusting device including a toothed bar which is fixed at one end to a brake cable of the motor vehicle. An elastic means acts on the toothed bar to move it when the cable loses tension. An engagement element engages the bar blocking the movement of the bar in a block position and releasing the bar in an unblock position, allowing cable tension adjustment. The elastic means acts on the engagement element so that it engages the bar and blocks the axial movement of the bar.

### SUMMARY OF THE DISCLOSURE

According to some implementations an automatic cable tensioning device is provided that comprises a support suitable for being coupled to a parking brake lever, a first regulating element suitable for being coupled to the cable, elastic means suitable for regulating the tension of the cable which act on the first regulating element, a second regulating element which is housed in the support being moved with respect to the support between a rest position where a relative movement between both regulating elements occurs for tensioning the cable and a block position where the second regulating element blocks the relative movement between both regulating elements.

According to some implementations the first regulating element comprises an outer thread traversing the second regulating element, whereas the second regulating element comprises an inner thread and a first contact surface. The inner thread of the second regulating elements cooperates with the outer thread of the first regulating element to move from the rest position the first regulating element with respect to the second regulating element towards the elastic means by means of rotation of the second regulating element when the first contact surface of the second regulating element is in contact with a first contact surface of the support. A stop of the second regulating element blocks the rotation of the second regulating element with respect to the first regulating element in the block position of the automatic tensioning device. The first regulating element is thus prevented from moving with respect to the second regulating element, the tension of the corresponding brake cable being reduced.

The self-tensioning device obtained is a compact device that is easy to maintain and assemble, and optimized in terms of the number of necessary elements. Additionally, the elements integrated in the device are less complex and easy to produce, so the cost of the assembly is also lower and more competitive compared with other known systems.

These and other advantages and features will become evident in view of the drawings and the detailed description of the invention.

### BRIEF DESCRIPTION OF THE DRAWINGS

FIG. 1 shows a perspective view of a parking brake with an automatic cable tensioning device in a block position.

FIG. 2 shows an exploded view of the parking brake shown in FIG. 1.

FIG. 3 is a section view of the parking brake shown in FIG. 1.

FIG. 4 is an exploded view of the automatic tensioning device shown in FIG. 1 without the unblocking means.

FIG. 5 is another exploded view of the automatic tensioning device shown in FIG. 1 without the unblocking means.

FIG. 6 is a section view of the automatic tensioning device shown in FIG. 1 in a rest position.

FIG. 7 is a section view of the automatic tensioning device shown in FIG. 1 in the block position.

FIG. 8 is a longitudinal section view of the automatic tensioning device shown in FIG. 1 in the block position.

FIG. 9 is a longitudinal section view of a second implementation of an automatic tensioning device in a block position.

FIG. 10 is a longitudinal section view of a third implementation of an automatic tensioning device in a block position.

FIG. 11 is a detail perspective view of the parking brake with the automatic tensioning device shown in FIG. 1, wherein the unblocking means is shown.

FIG. 12 is an exploded view of the unblocking means shown in FIG. 1.

FIG. 13 is a section view of the automatic tensioning device shown in FIG. 1 with the unblocking means shown in FIG. 10 in a safety position.

### DETAILED DESCRIPTION

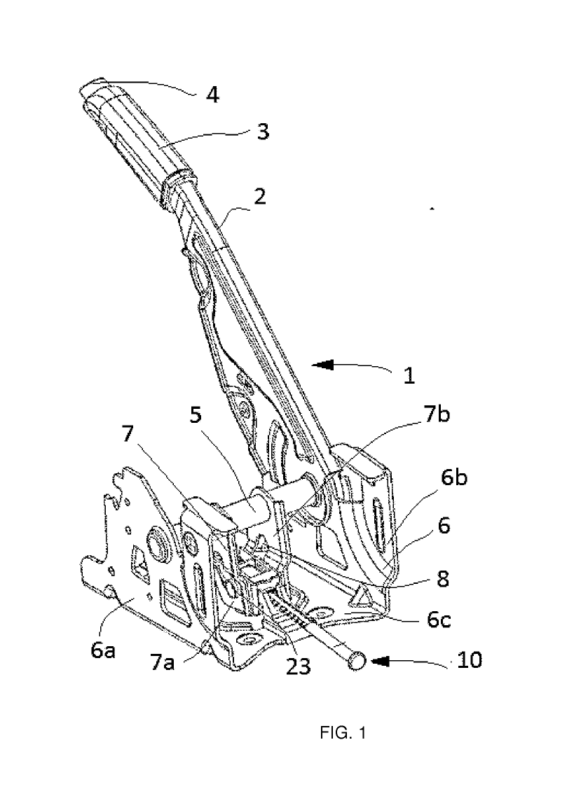

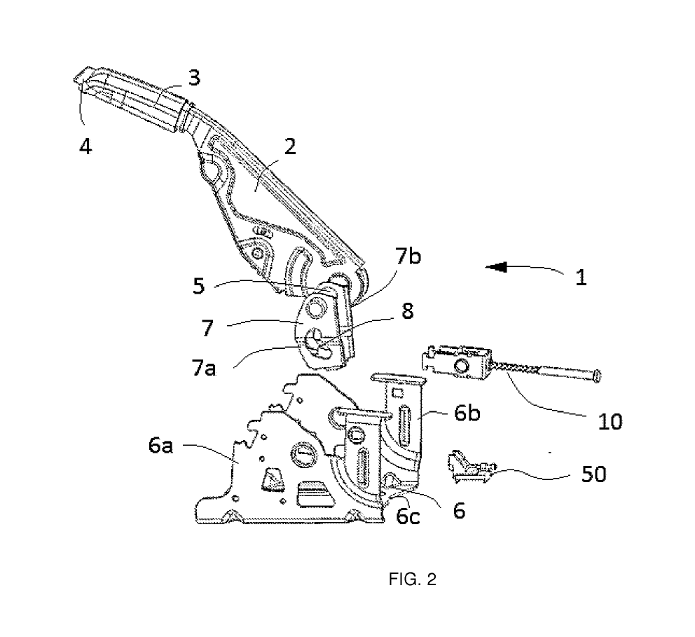

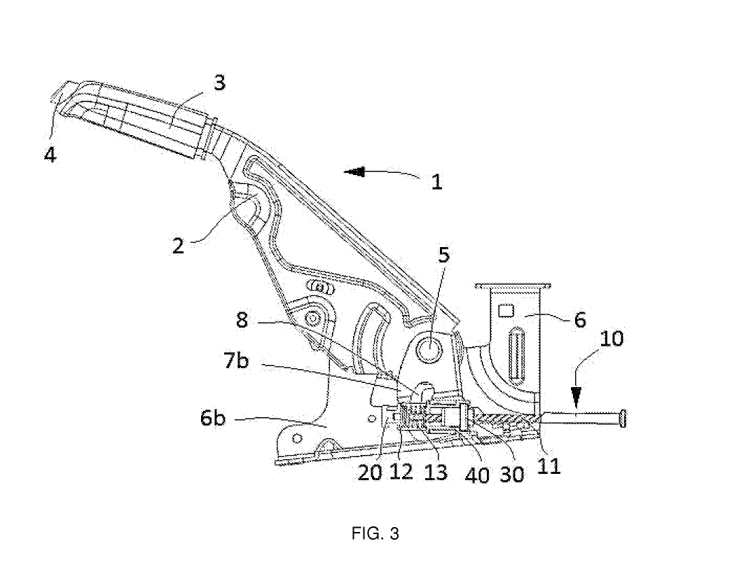

FIGS. 1 to 3 shows a parking brake 1 suitable for motor vehicles comprising an automatic cable tensioning device 10. The parking brake 1 comprises a support 6 suitable for being fixed to the motor vehicle, a lever 2 rotatably coupled to the support 6, and the automatic cable tensioning device 10 suitable for automatically tensioning a cable, not depicted, that can be connected to the brakes of the motor vehicle. The support 6 comprises side walls 6a,6b arranged substantially parallel to one another and as continuations of a base 6c, the lever 2 being coupled to the side walls 6a,6b of the support 6 through a shaft 5.

The parking brake 1 may also comprise an auxiliary support 7 comprising walls 7a,7b arranged substantially parallel to one another, which are integrally attached to one another and also attached to the lever 2 through the shaft 5. The automatic cable tensioning device 10 is arranged between the two walls 7a,7b of the auxiliary support 7, coupled to the walls 7a,7b. Each wall 7a,7b of the auxiliary support 7 comprises a closed groove 8 necessary for assembling and positioning the automatic tensioning device 10 on the auxiliary support 7.

The lever 2 is coupled to the shaft 5 at one end and comprises at the other end a grip 3 through which the driver grasps the parking brake 1 and an unblocking button 4 which the driver must press to go from a block position, also referred to as an activated parking brake position, shown in FIGS. 1 to 3, to a rest position in which the parking brake 1 is not activated. The mechanisms by which the lever 2 is maintained in the block position are known in the state of the art and will not be described herein.

In the exemplary implementations disclosed herein, the automatic tensioning device 10 may comprise a support 20,40 suitable for being coupled to the auxiliary support 7, a first regulating element 11 suitable for being coupled to the brake cable, elastic means 13 suitable for adjusting the tension of the cable in the rest position, and a second regulating element 30 which is housed in the support 20,40 and moved with respect to the support 20,40 between the rest position and the block position. Therefore, in the rest position, a relative movement between both regulating elements 11 and 30 occurs for tensioning the cable, whereas in the block position, the second regulating element 30 in collaboration with the support 20,40 blocks the relative movement between both regulating elements 11 and 30.

The first regulating element 11 traverses the support 20,40, the second regulating element 30 and the elastic means 13 being coupled through a support element 12. The first regulating element 11 comprises an outer thread 11 c traversing at least the second regulating element 30. According to some implementations the outer thread 11c is a trapezoidal thread. The trapezoidal thread has a wide enough thread pitch so as to assure that the thread is not irreversible in any case. This assuring that the first regulating element 11 can move freely, rotating the second regulating element 30 in the housing thereof without impediments, when the elastic means 13 pulls the first regulating element 11. In the implementations shown, the thread pitch is approximately equal to the diameter of the regulating element 11, with a thread angle of approximately 45°. Furthermore, the first regulating element 11 may have a substantially cylindrical geometry and comprise, in addition to the outer thread 11c, a first end 11a which is inserted into a substantially cylindrical projection 12b of the support element 12, and a second end 11b suitable for being fixed to the brake cable, not depicted, and transmitting the tension to the corresponding brakes of the motor vehicle.

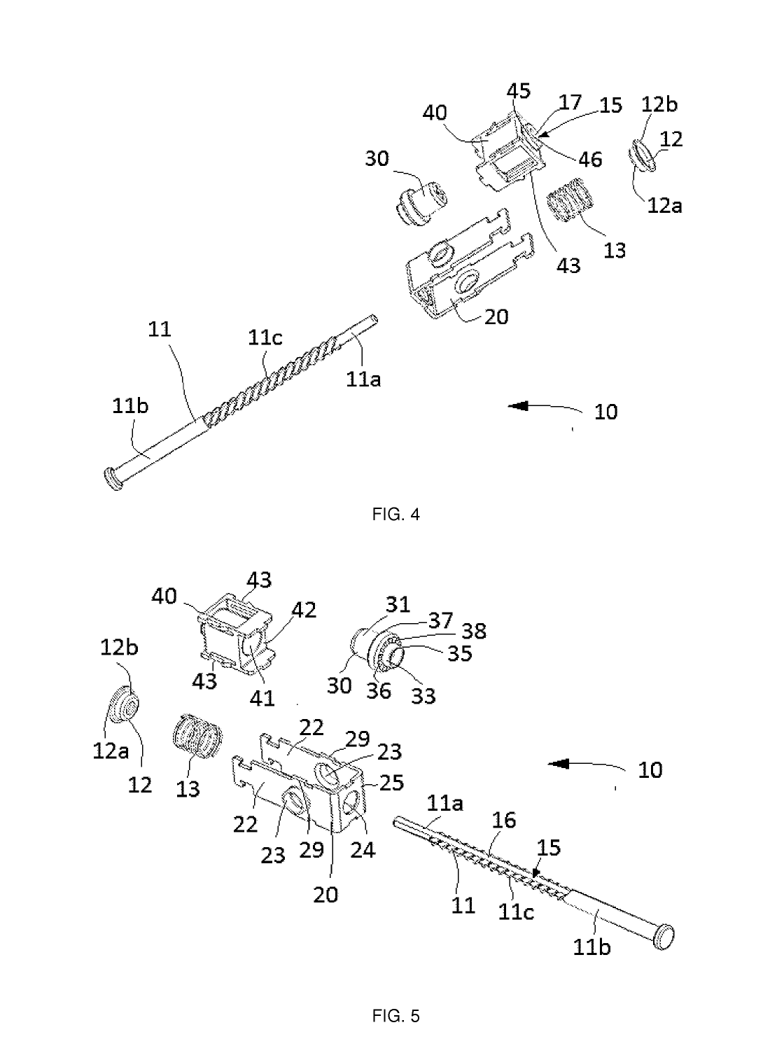

The elastic means 13 may comprise a tension spring, although other types of elastic means may be used. The elastic means 13 is supported in the support 40 and in a seat 12a of the support element 12, shown in FIGS. 4 and 5, tensioned against the support 40 due to the action of the first regulating element 11. In the second and third implementations of the automatic tensioning device 10, the elastic means 13 is also supported in the seat, not shown, tensioned against the support 40 due to the action of the first regulating element 11.

The support 20,40 comprises a first component 20 which is coupled to the lever 2 and a second support 40 fixed to the first component 20. The first component 20 comprises two arms 22 with side surfaces that are substantially parallel to one another attached through a base 25, configuring a substantially U-shaped part. The first component 20 comprises projections 23, each of which projects from one of the arms 22 being coupled in the corresponding groove 8 of the auxiliary support 7 of the parking brake 1. The first component 20 also comprises a hole 24 in the base 25 through which the first regulating element 11 traverse the first component 20.

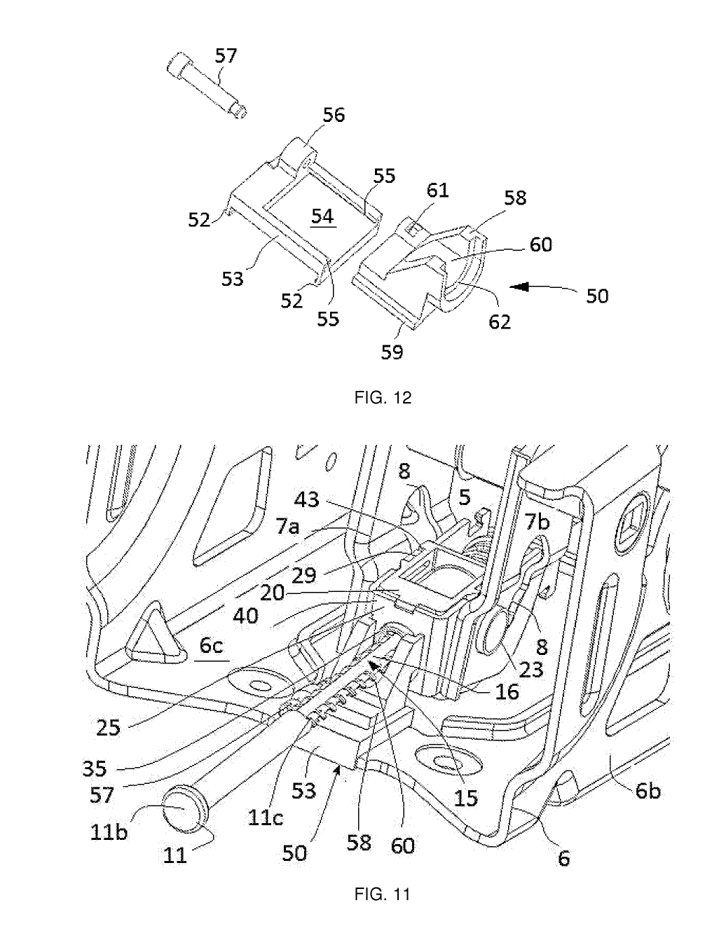

The second component 40 is housed inside the first component 20, being fixed to the first support 20 by means of clamping through flanges 29 projecting from each side surface 22 of the first component 20. The flanges 29 are inserted into notches 43 comprised in the second component 40, as is shown in FIG. 11.

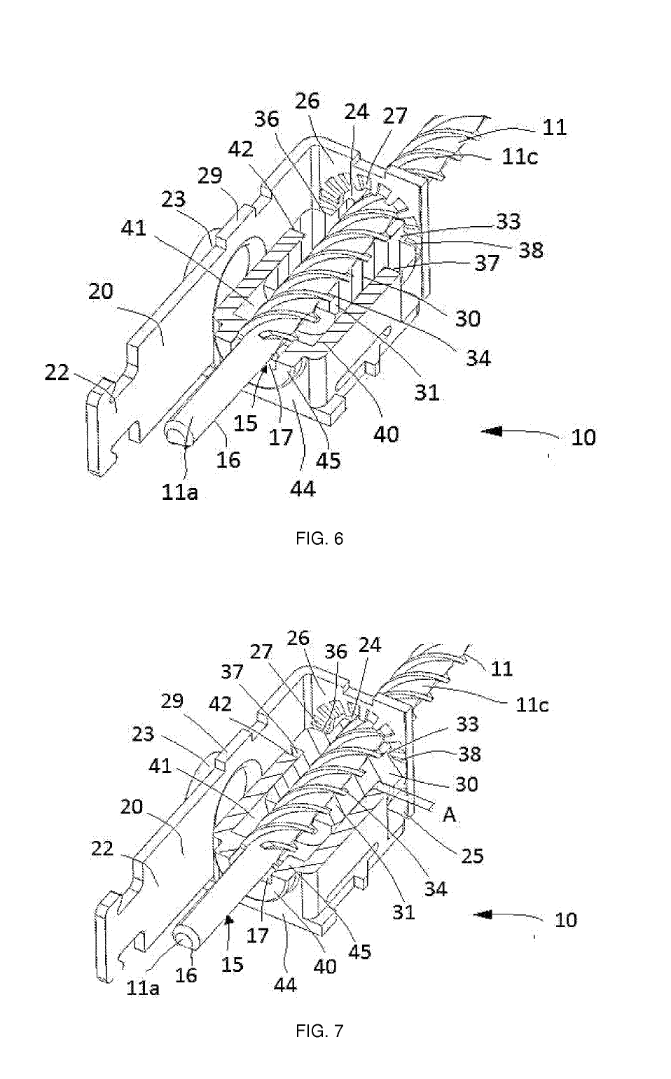

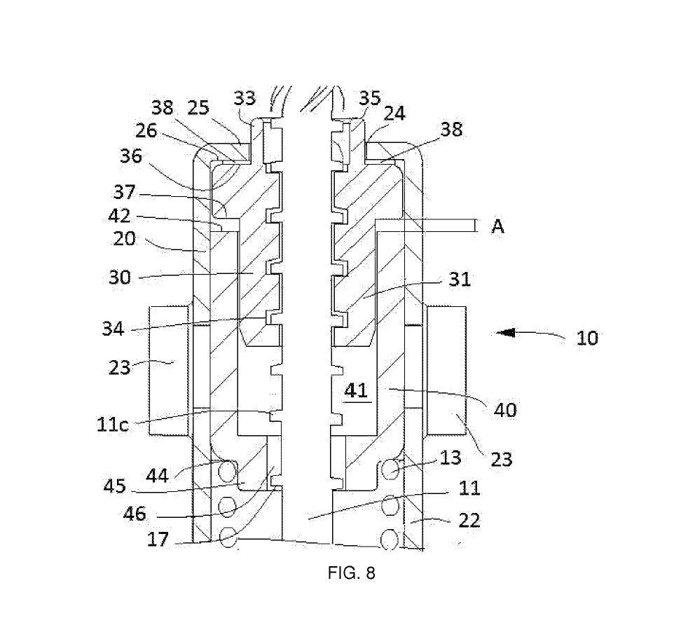

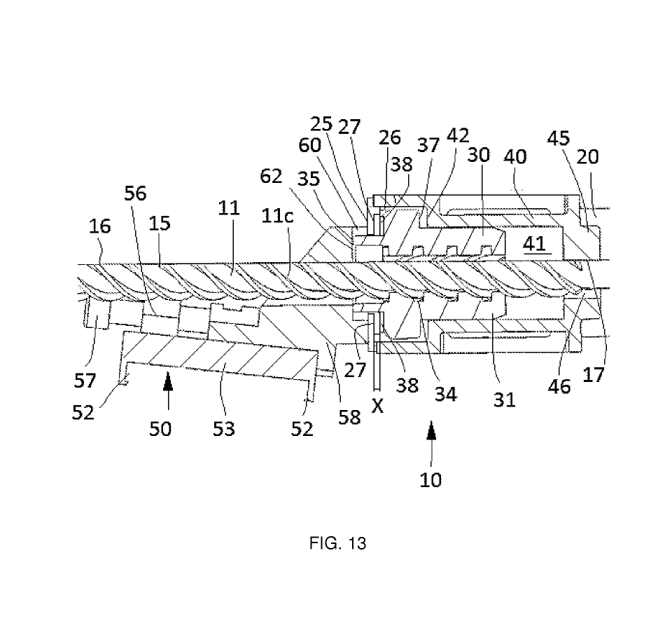

The second component 40 comprises a cavity 41 partially housing the second regulating element 30 therein, the element being moved in a guided manner in the cavity 41. The cavity 41 may have a substantially cylindrical geometry. The second component 40 comprises a support surface 44, shown in FIGS. 4 to 10, arranged substantially orthogonal to the cavity 41 on which there sit the elastic means 13 and a first stop surface 42, shown in FIGS. 6 to 10, with which the second regulating element 30 contacts in the rest position, the first stop surface 42 being arranged substantially parallel to the support surface 44. The first stop surface 42 and the support surface 44 delimitate the cavity 41. A substantially cylindrical projection 45, shown in FIGS. 4 and 13, on which the spring 13 is inserted extends in a substantially orthogonal manner from the support surface 44. The projection 45 comprises a hole 46 through which the first regulating element 11 passes through the second component 40.

The second regulating element 30 comprises an inner thread 34;34′, a first stop surface 37 for contacting the support 20,40 in the rest position, and at least one stop 38;36′;36″,34′ for blocking the movement of the first regulating element 11 with respect to the second regulating element 30 in the block position. The inner thread 34;34′ of the second regulating element 30 cooperates with the outer thread 11c of the first regulating element 11 to move, in the rest position, the first regulating element 11 with respect to the second regulating element 30 towards the elastic means 13 by means of rotation of the second regulating element 30 when the first stop surface 37 of the second regulating element 30 is arranged in contact with the first stop surface 42 of the second component 40 of the support 20,40.

The second regulating element 30 has a substantially cylindrical geometry, one of the ends 31 of which is housed inside the cavity 41 of the second component 40 of the support 20,40 whereas the other end 33 at least partially passes through the base 25 of the first component 20 of the support 20,40 through the hole 24. The first stop surface 37 is substantially orthogonal to the second regulating element 30. According to some implementations the first stop surfaces 37,42 are substantially planar surfaces. According to some implementations the first stop surfaces 37,40 have a minimum relative coefficient of friction of approximately 0.20 which allows the second regulating element 30 to rotate with respect to the support 20,40 with minimal resistance due to friction.

The required coefficient of friction depends on the thread pitch and angle of the respective thread elements 11c; 34; 11c; 34′ of the regulating elements 11,30 used in the implementations disclosed herein. If the thread pitch and angle are large, for example, a thread angle greater than approximately 45°, the axial tension generated by the elastic means 13 in the first regulating element 11 in turn causes an elevated rotating reaction in the thread 34; 34′ of the second regulating element 30. The elevated rotating reaction can rotate the second regulating element 30 when it overcomes the frictional forces which normally prevent the rotation, even though the frictional forces are relatively elevated. In contrast, if the thread pitch and angle are small, such as a thread angle less than approximately 45°, for example, the rotating reaction produced is small, so in order to assure the free rotating movement of the second regulating element 30, low frictional force must be assured by means of a low coefficient of friction between the moving contacting surfaces.

In the rest position in which the brake cable is not subjected to a load, in the event that the cable has been loosened and tension is lost, the elastic means 13 pulls the first regulating element 11 towards the elastic means 13, the second regulating element 30 being initially moved axially together with the first regulating element 11 until the first contact surface 37 of the second regulating element 30 contacts the first contact surface 42 of the support 20,40. After the moment, the second regulating element 30 rotates freely in one direction with respect to the first regulating element 11, moving the first regulating element 11 towards the elastic means 13 until the forces of the elastic means 13 are balanced with the reaction forces in the brake cable.

The first regulating element 11 does not rotate with respect to the second regulating element 30, nor with respect to the support 20,40, however, it can move with respect to the support 20,40. To prevent the rotation, the automatic tensioning device 10 comprises blocking means 15. The blocking means 15, shown in FIGS. 4 to 7 and 13, comprise in the first regulating element 11, a first substantially planar face 16 extending longitudinally from at least the first end 11a of the first regulating element 11,11′ and a second substantially planar face 17 in the second component 40 delimiting the hole 46 of the projection 45 of the second component 40, the faces 16,17 being arranged facing one another, blocking any attempt of rotation of the first regulating element 11 with respect to the second component 40 and therefore with respect to the first component 20 of the support 20,40.

When the driver operates the lever 2 for braking, the force exerted by the cable is greater than the reaction force of the elastic means 13 so the first regulating element 11 is moved axially, driving the second regulating element 30 until it contacts the stop 38;36′;36″,34″ which blocks the movement of the second regulating element 30, the second regulating element 30 thus being prevented from rotating in an opposite direction, reducing the tension of the brake cable. The second regulating element 30 is moved axially a distance A, shown in FIGS. 7 to 10, with respect to the support 20,40 until the stop 38;36′;36″,34″ blocks the movement thereof, the movement being perceived by the driver as a force-free or tension-free movement in the lever 2.

According to some implementations this movement is between approximately 0.5 mm to approximately 1.0 mm.

In the first implementation shown in detail in FIGS. 6 to 8, the second regulating element 30 comprises a plurality of stops 38 projecting axially from a surface 36, arranged facing the base 25 of the first component 20 of the support 20,40. The stops 38 are radially distributed. The first component 20 of the support 20,40 in turn comprises axially extending notches 27 in an inner surface 26 of the base 25. The notches 27 are radially distributed and cooperate with the respective stops 38, each of which is housed in a respective notch 27 blocking the rotation of the second regulating element 30 with respect to the support 20,40. The second regulating element 30 thus collaborates with the support 20,40 to block the movement of the first regulating element 11 with respect to the support 20,40, preventing a reduction of tension of the brake cable.

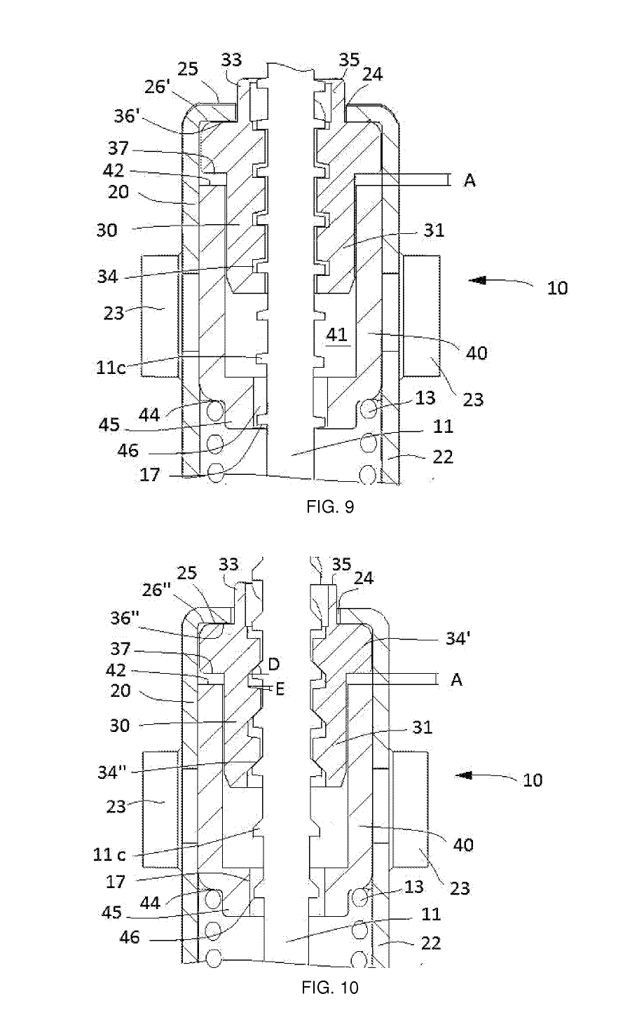

According to some implementations, as shown in FIG. 9, the second regulating element 30 comprises a stop 36′ which is arranged facing the base 25 of the first component 20. The stop 36′ is substantially planar. In the block position, the stop 36′ abuts against an inner surface 26′ of the base 25 of the first component 20 of the support 20,40, blocking the axial movement of the second regulating element 30 with respect to the support 20,40. Both the stop 36′ and the inner surface 26′ of the base 25 are arranged substantially parallel to one another, and substantially parallel to the first stop surfaces 37,42. Furthermore, the stop 36′ and the inner surface 26′ have a high relative coefficient of friction between both surfaces of at least approximately 1.0, such that it blocks the rotation of the second regulating element 30 with respect to the support 20,40, as well as the relative movement between both elements, preventing the first regulating element 11 from moving with respect to the second regulating element 30, the tension of the brake cable being reduced.

As disclosed above, the required coefficient of friction depends on the thread angle and on the thread pitch of the outer thread 11c of the first regulating element 11 and of the inner thread 34 of the second regulating element 30 used in each implementation.

Both in the first implementation shown in FIGS. 6 to 8 and in the second implementation shown in FIG. 9, the inner thread 34 of the respective second regulating element 30 and the outer thread 11c of the first regulating element 11 are symmetrical threads, respectively, with respect to a respective transverse plane.

In a third implementation of the automatic tensioning device 10, as shown in FIG. 10, the second regulating element 30 comprises a first stop 34″ in the inner thread 34′. In such implementations the outer thread 11c of the first regulating element 11 and the inner thread 34′ of the second regulating element 30 are asymmetrical threads. The angle D of a first flank of the thread should be wide, of at least approximately 45°, the stop 34″ being a delimiting surface of the first flank. The angle E of a second flank should be as close to 0° as possible. In the block position, the outer thread 11c thus contacts the stop 34″, generating a large friction on the contacting surface and thereby blocking the rotation of the second regulating element 30. Furthermore, the second regulating element 30 may comprise a second stop 36″ suitable for abutting against the inner surface 26″ of the base 25 of the first component 20 of the support 20,40, blocking the axial movement of the second regulating element 30 with respect to the support 20,40. The friction between the inner surface 26″ and the second stop 36″ may contribute to preventing the movement of the first regulating element 11 with respect to the second regulating element 30 to it prevents the second regulating element 30 from rotating freely. The second stop 36″ and the inner surface 26″ of the base 25 may be arranged substantially parallel to one another and substantially parallel to the first stop surfaces 37,42.

The parking brake 1 may comprise a unblocking means 50 as shown in FIGS. 10 to 13 to assure that the automatic tensioning device 10 is capable of being released every time it returns to the rest position. The unblocking means 10 may be common in the implementations disclosed herein. The unblocking means 50 is configured to prevent the brake cable from automatically tensioning erroneously under extreme circumstances of cold, dirtiness, etc., forcing the second regulating element 30 to unblock when the lever 2 goes back to the rest position.

The unblocking means 50 is suitable for being fixed to the support 6 of the parking brake 1 and for acting on the second regulating element 30 in the rest position, longitudinally moving it with respect to the first regulating element 11.

According to some implementations the unblocking means 50, shown in detail in FIG. 11, comprises a fixed base 53 suitable for being fixed to the support 6 of the parking brake 1, particularly to the base 6c of the support 6, a moving base 58 which is moved in a guided manner with respect to the fixed base 53, and an adjustment screw 57 suitable for positioning the moving base 58 such that when the automatic tensioning device 10 is in the rest position, the moving base 58 acts on the second regulating element 30 forcing the movement of the second regulating element 30 with respect to the support 20,40 to a safety position shown in FIG. 13.

The fixed base 53, shown in detail in FIG. 12, comprises a substantially planar surface 54 on which the moving base 58 is supported and moves, and inner guides 55 collaborating with outer guides 59 of the moving base 58 for the guided movement of the moving base 58 with respect to the fixed base 53. The fixed base 53 further comprises a coupling 56 for the adjustment screw 57 and flanges 52 which retain the fixed base 53 against the support 6 of the parking brake 1.

The moving base 58 comprises a housing 60 extending in the direction of movement of the moving base 58 with respect to the fixed base 53, the first regulating element 11 being housed in the housing 60. The moving base 58 also comprises a substantially planar thrust surface 62 suitable for acting against the unblocking surface 35 of the second regulating element 30, moving the second regulating element 30 towards the elastic means 13. The moving base 58 hits against the substantially orthogonal unblocking surface 35. The thrust surface 62 may be arranged substantially orthogonal to the first regulating element 11 and substantially parallel to the unblocking surface 35. The thrust surface 62 may have a substantially U-shaped cross-section.

The moving base 58 may comprises a threaded housing 61 for the adjustment screw 57, such that when the operator rotates the adjustment screw 57, the moving base 58 is moved with respect to the fixed base 53. The distance between the unblocking surface 35 and the thrust surface 62 in the rest position can vary significantly due to manufacturing and assembly tolerances. The adjustment screw 57 minimizes the distance by absorbing the tolerances, given that it allows adjusting the position of the moving base 58 with respect to the second regulating element 30 at the end of the assembly process.

As described above, there is a transition between the rest position and the block position during which the second regulating element 30 is moved axially a distance A, shown in FIGS. 7 to 10, together with the first regulating element 11, with respect to the support 20,40. The movement will be perceived by the driver acting on the lever 2 as a force-free or tension-free movement in the lever 2. According to some implementations the distance A is at most approximately 1.0 mm, preferably being approximately 0.5 mm. In the rest position of the automatic tensioning device 10, the unlocking means 50 act on the second regulating element 30, moving it a distance X to the safety position, shown in FIG. 13, for the purpose of unlocking the automatic tensioning device 10. A force-free or tension-free movement perceived by the driver when going from the rest position to the block position is thus further minimized. The driver will perceive the movement between the safety position and the block position, which is less than the movement between the rest position and the block position, as a tension-free movement. According to some implementations, the distance X travelled by the second regulating element 30 between the rest position and the safety position is approximately 0.5 mm.

Although the parking brake comprising the first implementation of the automatic tensioning device is only depicted in FIGS. 1 to 3, it is appreciated that the parking brake would be similar in the case of the second and third implementations of the automatic tensioning device, the description of the elements forming the parking brake provided at the beginning of the disclosure can therefore be extended to the brake comprising the second and third implementations of the automatic tensioning device.

What is claimed is:

1. An automatic cable tensioning device for a parking brake actuator of a vehicle comprising:
a support suitable for being coupled to a lever of the parking brake actuator,
a first regulating element suitable for being coupled to a cable that connects the parking brake actuator to a brake of the vehicle, the first regulating element comprising a non-rotatable shaft having an outer thread,
a rotatable second regulating element housed in the support and axially moveable with respect to the support between a rest position and a block position, in the rest position there being relative movement between the first and second regulating elements to facilitate a tensioning of the cable, in the block position movement of the second regulating element is impeded to prevent relative movement between the first and second regulating elements, the outer thread of the first regulating element passing through at least a portion of the second regulating element, the second regulating element comprising an inner thread that cooperates with the outer thread of the first regulating element to induce axial movement of the first regulating element with respect to the second regulating element when the second regulating element is moved between the rest position and the block position; and
an elastic member that acts upon the first regulating element, the elastic member being suitable for regulating the tension of the cable, upon the second regulating element moving between the rest position and the block position the first regulating element is moved towards the elastic member as a result of a rotation of the second regulating element.

2. The automatic cable tensioning device according to claim 1, wherein the second regulating element comprises a first stop arranged to interface with a first portion of the support when the second regulating element is in the rest position.

3. The automatic cable tensioning device according to claim 2, wherein the second regulating element comprises a second stop arranged to interface with a second portion of the support when the second regulating element is in the block position.

4. The automatic cable tensioning device according to claim 2, wherein the first stop comprises a first surface of the second regulating element and the first portion of the support comprises a first surface of the support, the first surface of the second regulating element and the first surface of the support being substantially planar surfaces.

5. The automatic cable tensioning device according to claim 4, wherein each of the first surfaces of the second regulating element and the support have a coefficient of friction of less than 0.2.

6. The automatic cable tensioning device according to claim 1, wherein the second regulating element is movable axially with respect to the support a maximum distance of approximately 1.0 mm between the rest position and the block position.

7. The automatic cable tensioning device according to claim 1, wherein the second stop comprises a plurality of radially distributed stops projecting axially from the second regulating element, and the second portion of the support comprises radially distributed notches, the a plurality of radially distributed stops cooperating with the respective notches for blocking the rotation of the second regulating element with respect to the support.

8. The automatic cable tensioning device according to claim 3, wherein the second stop comprises a second surface of the second regulating element and the second portion of the support comprises a second surface of the support, the second surface of the second regulating element configured to collaborate with the second surface of the support to block the rotation of the second regulating element, each of the second surfaces having a coefficient of friction of at least approximately 1.0.

9. The automatic tensioning device according to claim 8, wherein the second surface of the second regulating element and the second surface of the support are arranged substantially parallel to one another.

10. The automatic cable tensioning device according to claim 1, wherein the inner thread of the second regulating element is a symmetrical trapezoidal thread.

11. The automatic cable tensioning device according to claim 1, wherein the inner thread of the second regulating element is an asymmetrical trapezoidal thread.

12. The automatic tensioning device according to the preceding claim, wherein the second regulating element comprises a first stop in the inner thread, delimiting a first minimum thread flank angle of approximately 45 degrees, the first stop adapted to collaborate with the at least a portion of the outer thread of the first regulating element to block the rotation of the second regulating element with respect to the first regulating element.

13. The automatic tensioning device according to claim 12, wherein the second regulating element comprises a second stop arranged to interface with a portion of the support when the second regulating element is in the block position to prevent axial movement of the second regulating element.

14. The automatic cable tensioning device according to claim 13, wherein the second stop comprises a surface of the second regulating element and the portion of the support comprises a surface of the support, the surface of the second regulating element and the surface of the support arranged substantially parallel to one another.

15. The automatic cable tensioning device according to claim 1, wherein the non-rotating shaft of the first regulating element includes a substantially planar first face extending longitudinally along at least one end of the shaft, the support having a substantially planar second face extending longitudinally along at least one end of the support, the first and second faces being arranged facing one another to prevent the rotation of the first regulating element with respect to the support.

16. The automatic cable tensioning device according to claim 1, wherein the support comprises a first component that is coupled to the lever and a second component fixed to the first component, the second component comprising a first stop surface, a support surface arranged substantially parallel to the first stop surface and a cavity situated between the support surface and the first stop surface, the second regulating element moveable in a guided manner within the cavity, a first end of the elastic member being supported on the support surface.

17. The automatic cable tensioning device according to claim 16, wherein the first regulating element passes through the elastic member, the first regulating element being coupled to a second end of the elastic member through a support element comprising a seat on which the second end of the elastic member is supported.

18. The automatic cable tensioning device according to claim 1, wherein the elastic member is a tension spring.

19. A parking brake actuator comprising the automatic cable tensioning device of claim 1, the parking brake actuator comprising an unblocking assembly suitable for being fixed to a support of the parking brake actuator and acting on the second regulating element in the rest position to move the second regulating element longitudinally with respect to the first regulating element.

20. The parking brake actuator according to claim 19, wherein the unblocking assembly comprises a fixed base suitable for being fixed to the support of the parking brake actuator, a moving base which is moveable in a guided manner with respect to the fixed base, and an adjustment screw suitable for positioning the moving base in an unblock position such that the moving base acts on the second regulating element to move the second regulating element to a safety position between the rest position and the block position.
